(19) United States
(12) Patent Application Publication
(10) Pub. No.: US 2008/0087790 A1
(43) Pub. Date: Apr. 17, 2008

(54) Brace stand and an electronic device for using the same

(75) Inventor: Li Tien Tseng, Bade City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/798,273

(22) Filed: May 11, 2007

(30) Foreign Application Priority Data
Oct. 14, 2006 (TW) 095137896

(51) Int. Cl. F16M 13/00

(52) U.S. Cl. 248/624

(57) ABSTRACT

A brace stand and an electronic device for using the same. The brace stand and the electronic device for using the same comprise an electronic device, a brace structure and a base. The electronic device has a housing at the back side. The top end part of the brace structure connects to the back side housing and the bottom end part connects to the base. The base has a tail portion including a hook, wherein the base is able to rotate between a brace position and a folding area. While the base is located in the folding area, the hook fastens to the back side housing.

This application claims priority based on a Taiwanese patent application No. 095137896 filed on Oct. 14, 2006

### BACKGROUND OF THE INVENTION

1. Field of the Invention

The present invention relates generally to a brace stand and an electronic device for using the same; particularly, the present invention relates to an adjustable brace stand and an electronic device for using the same.

2. Description of the Prior Art

The progress of the electronic display device technology fulfills mankind's various needs in the information society. Widely applied in the products such as personal digital assistant, PC monitor, household electronic appliances and even billboard, the electronic display device has become more and more important in our daily life. There are two common types of brace stand used for the electronic display device so far, one is the immobile type and the other is the adjustable type. The former type of brace stand usually fastens to the display device, capable of providing a stable support, yet the height of the electronic display device is not adjustable. As to the latter type of brace stand, though it provides the height-adjustable solution for the display device, however, there often accompanies with the drawback that the base of the brace stand is unable to be folded in the back side of the display device due to its volume and shape, not to mention providing the users the function for hanging the display device on the wall.

FIG 1a shows a conventional structure of the adjustable brace stand. As FIG. 1a shows, the brace axle 30 has two ends, one end is connected to the base 40 and the other end is connected to the display device 20. As shown in FIG. 1a, the base is unable to be folded in the back side of the display device due to its relatively bigger volume; furthermore, there is a limited range for the height adjustment, for the design structure of the brace axle is a single flat element. Another conventional structure of the adjustable brace stand is shown in FIG. 1b. In the embodiment, the brace axle 30 is composed of a top element 31 and a bottom element 32. The height of the display device 20 may be adjustable by varying the angle between the top element 31 and the bottom element 32. However, the volume of the base of the brace stand is still relatively bigger, and the base of the brace stand is unable to be completely folded in the back side of the display device 20, thus this structure is also inconvenient for the users to hang the display device on the wall.

### SUMMARY OF THE INVENTION

It is an object of the present invention to provide a brace stand which may be completely folded in the back side of the device that needs bracing. It is another object of the present invention to provide an adjustable brace stand and the electronic device for using the same. The brace stand of the present invention is capable of completely folded in the back side of the electronic device. In addition to save the package volume, it also helps users a better use of the space and decrease the inconvenience of the base connection. It is a further object of the present invention to provide a brace stand which may become a cable arrangement structure while the users hang the display device on the wall.

The present invention of the brace stand and an electronic device for using the same comprise an electronic device, a brace structure and a base. The electronic device has a housing at the back side. The top end part of the brace structure connects to the back side of the housing and the bottom end part pivotally connects to the base. The base has a tail portion including a hook, wherein the base is able to rotate between a brace position and a folding area. While the base is located in the folding area, the hook fastens to the back side of the housing.

The present invention of the brace stand and the electronic device for using the same further comprising a guidance and a slidable module. The back side of the electronic device has a protrusion portion coupled with the guidance, the brace structure includes a brace axle and the slidable module, and the top portion of the brace axle connects to the slidable module, wherein the slidable module is disposed corresponding to the guidance, jointly drawing the brace axle into the guidance and producing a displacement along the axis, making the brace axle moveably connected to the main body of the electronic device. The base includes a tail portion having a hook, wherein the base is capable of rotating between a brace position and a folding area relative to the brace structure. While the base is located in the folding area, the hook fastens to the back side of the housing.

### BRIEF DESCRIPTION OF THE DRAWINGS

FIG. 1a shows a conventional structure of the adjustable brace stand;

FIG. 1b shows another conventional structure of the adjustable brace stand;

FIG. 2a illustrates a preferred embodiment of the brace stand of the present invention;

FIG. 2b illustrates another preferred embodiment of the brace stand of the present invention;

FIG. 2c illustrates another preferred embodiment of the brace stand of the present invention;

FIG. 2d shows a rear view of the preferred embodiment of the brace stand of the present invention folding in the back side of the electronic device;

FIG. 2e is a lateral view of the preferred embodiment of the brace stand of the present invention folding in the back side of the electronic device;

FIG. 2f is a bottom view of the preferred embodiment of the brace stand of the present invention folding in the back side of the electronic device;

FIG. 2g is another preferred embodiment of the brace stand of the present invention;

FIG. 3a is a schematic diagram of the preferred embodiment of the brace stand of the present invention rotating between a brace position and a folding area;

FIG. 3b is a schematic diagram of the preferred embodiment of the brace stand of the present invention rotating to the brace position;

FIG. 4a is an explosive view of the brace stand of the preferred embodiment of the present invention;

FIG. 4b is a movement diagram of the preferred embodiment of the brace stand of the present invention rotating to the folding area;

FIG. 4c is a combination diagram of the preferred embodiment of the brace stand of the present invention;

FIG. 5a is a megascopic diagram of the area where the base connects to the brace structure when the brace stand of the present invention is located in the folding area;

FIG. 5b is a megascopic diagram of the area where the base connects to the brace structure when the brace stand of the present invention is positioning in the brace position;

FIG. 6a is a lateral view of the preferred embodiment of the brace stand of the present invention functioning as a cable arrangement structure;

FIG. 6b is a rear view of the preferred embodiment of the brace stand of the present invention functioning as a cable arrangement structure;

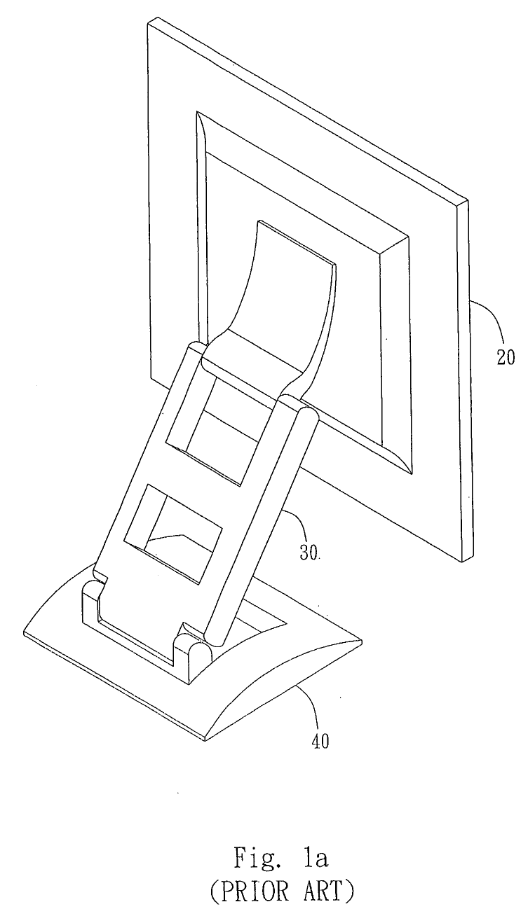

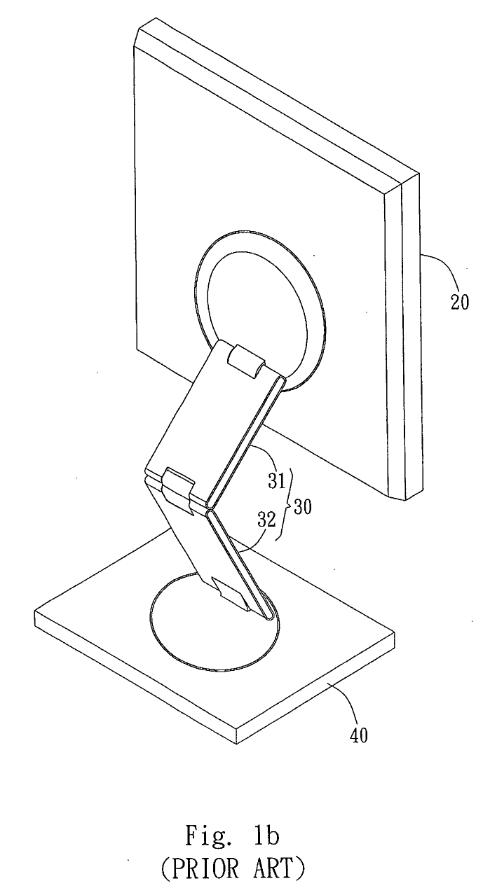

### DETAILED DESCRIPTION OF THE PREFERRED EMBODIMENT

The present invention provides a brace stand which may be completely folded in the back side of the device that needs bracing. The present invention also provides an adjustable brace stand having an adjustable brace structure. While the base of the brace stand is completely folded in the back side of the device that needs bracing, the elastic element of the adjustable brace structure may provide enough elastic force pressing downwards the brace axle and thus makes the base fasten to the device that needs bracing. The wording “adjustable” mentioned here refers to the appearance that the height between the main body of the electronic device and the base is adjustable by adjusting the axial displacement of the brace structure. The brace stand of the present invention is preferably applied to the electronic device such as liquid crystal display device. However, in another embodiment, the brace stand of the present invention may be applied to some portable liquid crystal display device such as digital storage player/viewer, digital pocket television, liquid crystal display device used in vehicles or other plane display device as well.

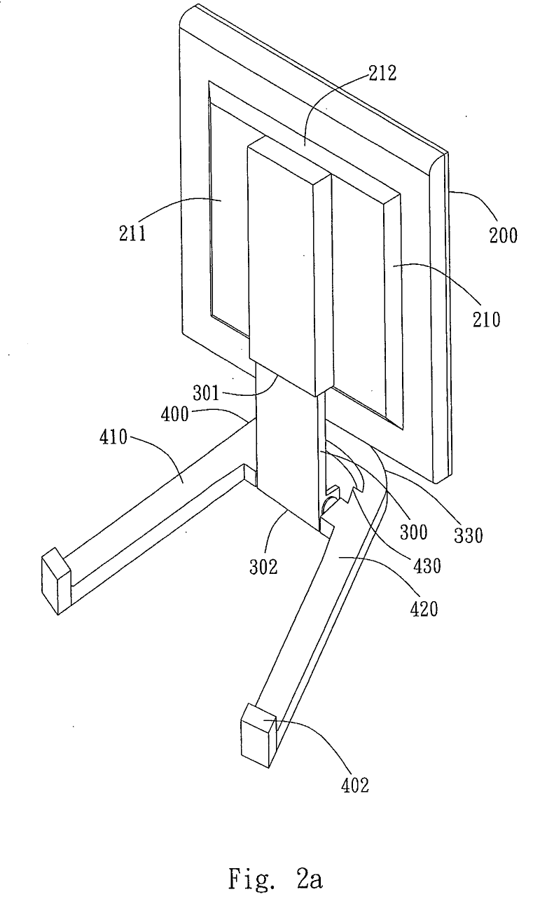

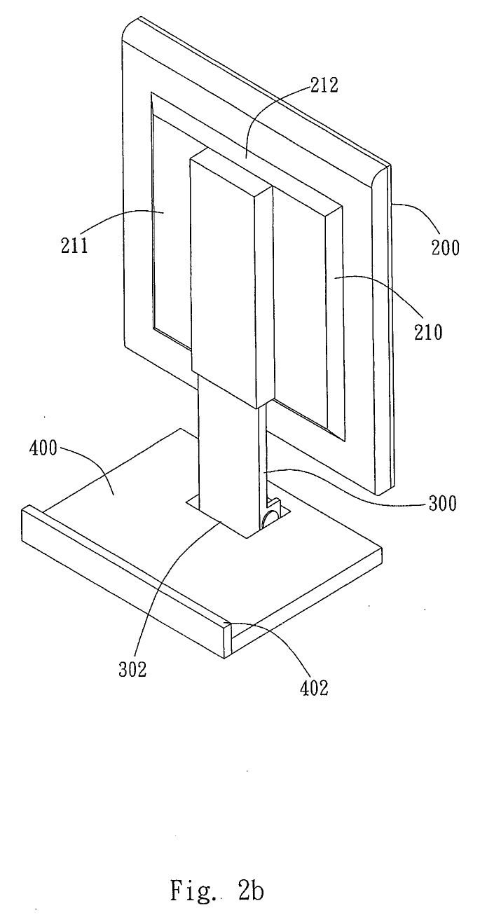

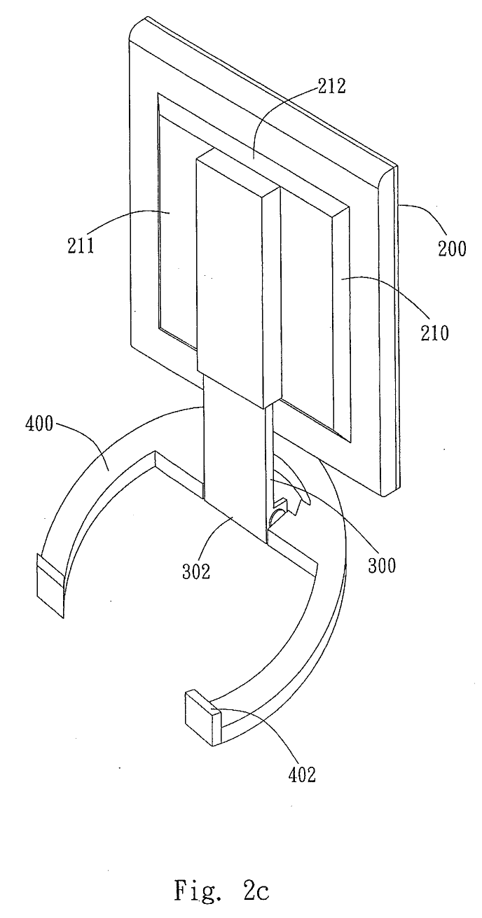

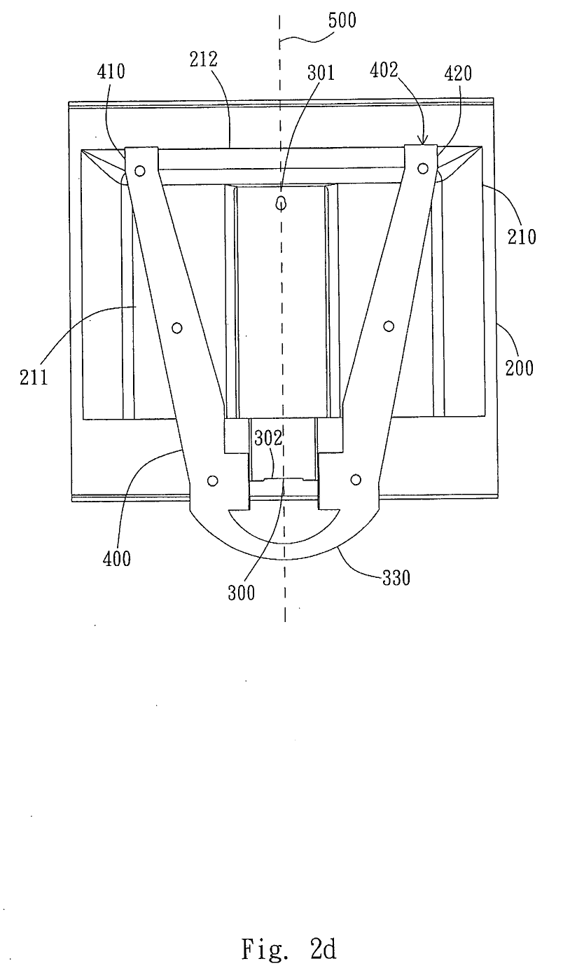

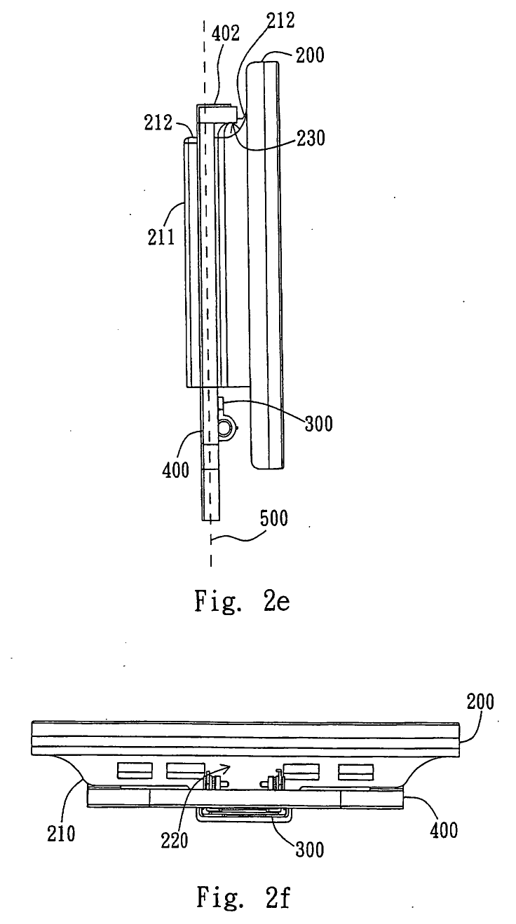

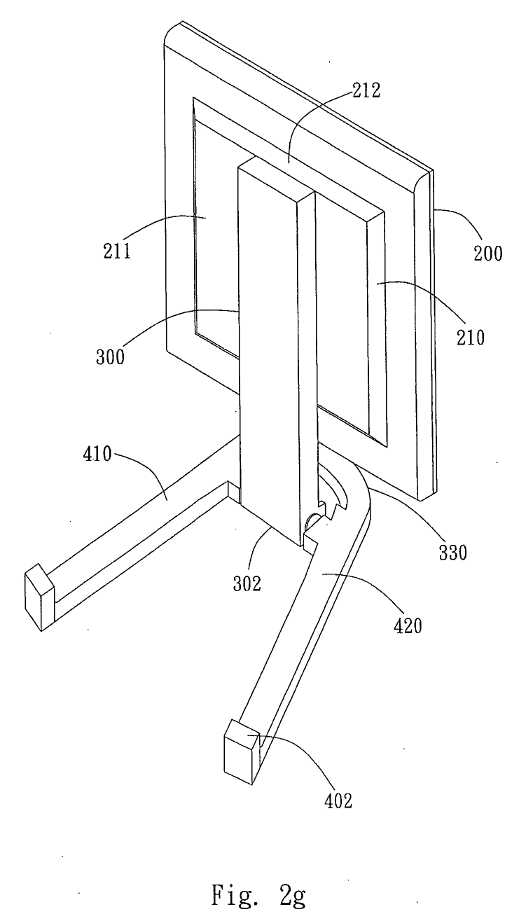

In the preferred embodiment, the brace stand and the electronic device for using the same comprises a main body 200, a brace structure 300 and a base 400. As FIG. 2a shows, the main body 200 includes a back side housing formed as a protrusion portion 210 on the back side of the electronic device, wherein the protrusion portion 210 has a back 211 and a top 212. As the preferred embodiment shown in FIG. 2a, the protrusion portion 210 connected to the brace structure 300 is preferably rectangular. However, in another embodiment, the shape of the protrusion portion 210 may also be circular, U shaped or other geometric shape. As FIG. 2a shows, the brace stand 300 includes a top end part 301 and a bottom end part 302, wherein the top end part 301 of the brace structure 300 connects to the main body 200 of the electronic device and the bottom end part 302 pivotally connects to the base 400. As the preferred embodiment shown in FIG. 2a, the base 400 includes a first leg 410 and a second leg 420, and each of the first and the second legs has a tail end part formed as a hook 402 and a front end part opposite to the tail end part. The front end parts join each other to form a connection portion 430 which pivotally connects the base 400 and the bottom end part 302 of the brace structure 300. As FIG. 2a shows, the connection portion 430 connects the first leg 410 and the second leg 420 and is preferably to be shaped as an arc structure 320. However, in another embodiment, the connection portion 430 may be a rectangular structure or other polygon structure as well. In another embodiment, the base 400 may also be a plane structure as FIG. 2b shows. The shape of the plane structure is preferably square, rectangular or semi-elliptic, wherein the front end part of the plane structure pivotally connects to the bottom end part 302 of the brace structure 300, and the tail portion of the plane structure is formed as the hook 402. Furthermore, in another embodiment, as FIG. 2c shows, the base 400 also includes the leg with U shape or semi-circular shape, the front end part of the leg pivotally connects to the bottom end part 302 of the brace structure 300, and the tail portion of the leg is formed as the hook 402.

As the preferred embodiment shown in FIG. 2d, the base 400 may be completely folded in the folding area 500 and fasten to the top 212 of the protrusion portion 210 by the hook 402. In addition, as the preferred embodiment shown in FIG. 2e, the top 212 of the protrusion portion 210 has at least a slot 230, provided for the hook 402 to wedge in it. As FIG. 2f shows, the bottom of the protrusion portion 210 preferably includes a hole 220 provided for embracing the brace structure 300. As FIG. 2e and FIG. 2f show, the brace structure 300 extends into the hole 220 and connects to the main body 200 of the electronic device. However, in another embodiment, the brace structure 300 may be extended from the bottom of the protrusion portion 210 by injection molding and thus pivotally connected to the base 400 as FIG. 2g shows.

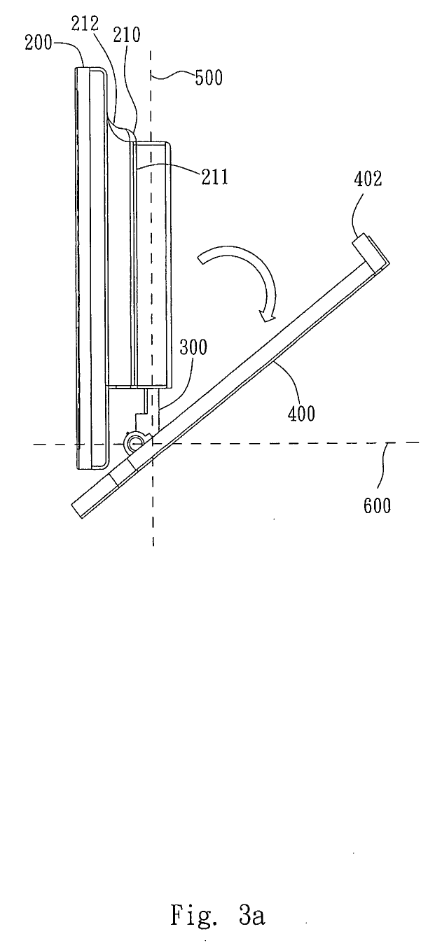

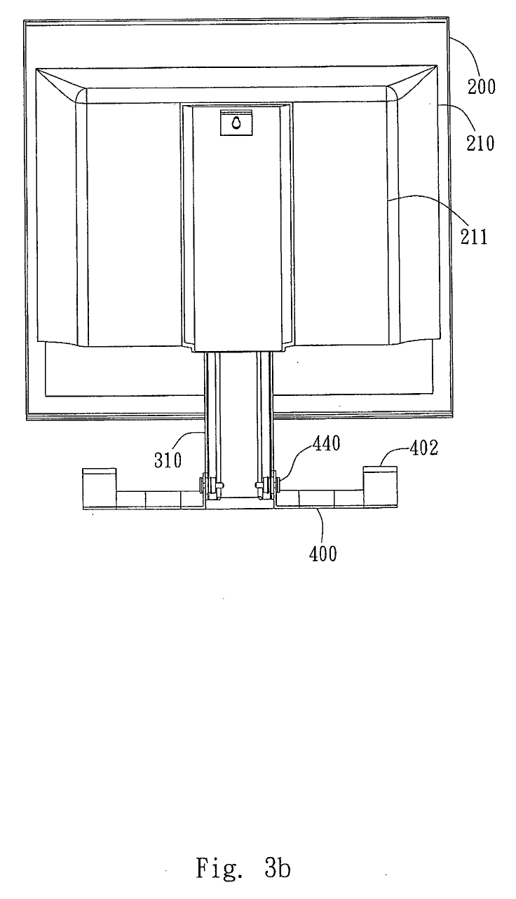

As FIG. 3a shows, in this preferred embodiment, the base 400 is capable of rotating between a folding area 500 and a brace position 600 relative to the brace structure 300. When the base 400 is located in the folding area 500, the base 400 is substantially parallel to the back 211 of the protrusion portion 210 and the hook 402 fastens to the top 212 of the protrusion portion 210. As the preferred embodiment shown in FIG. 3a, when the base 400 is positioning in the brace position 600, the base 400 is substantially vertical to the back 211 of the protrusion portion 210 and the brace structure 300 connects to the base 400 with an intersecting angle of around 90 degrees. Meanwhile, the base 400 is substantially parallel to the surface where the electronic device located and joins with the brace structure 300 to support the main body 200 of the electronic device as FIG. 3b shows. However, in another embodiment, the base 400 may rotate to a position to form different intersecting angles from the brace position 600 and provide support to the brace structure 300 of the electronic device.

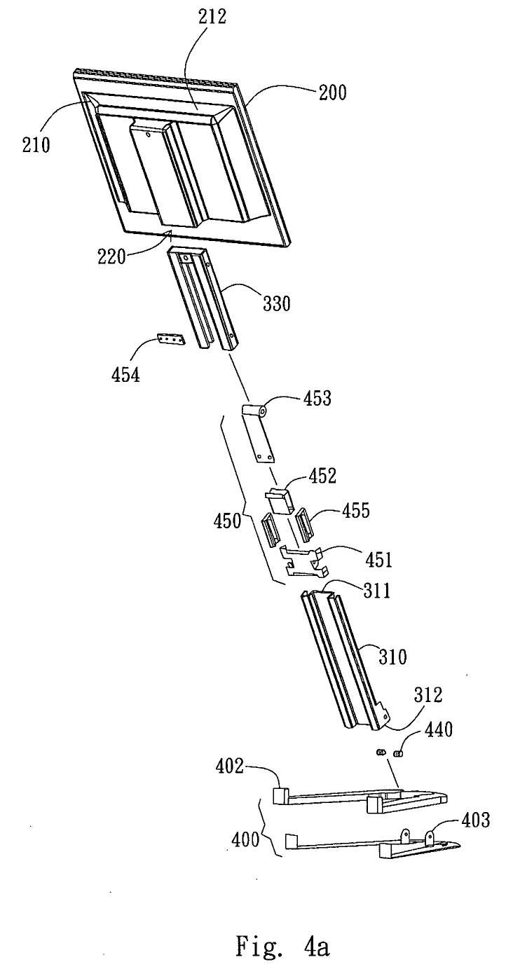

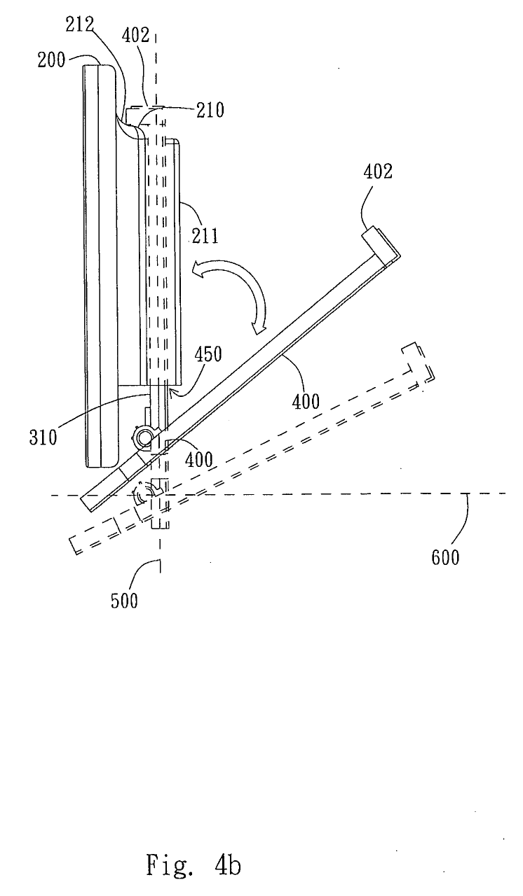

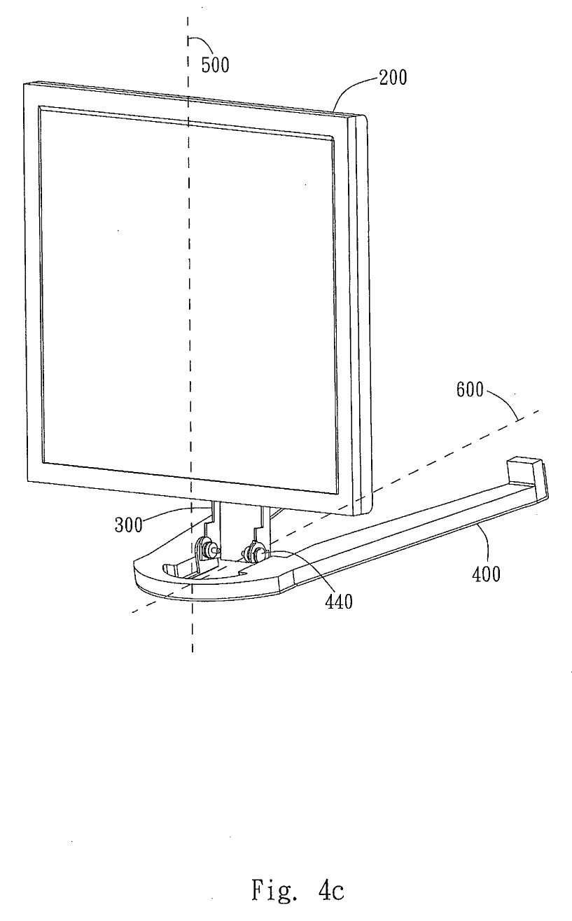

The preferred embodiment of the brace stand of the present invention further comprises an adjustable brace structure. In other words, the brace structure 300 of the present invention preferably comprises a guidance 330, a slidable module 450 and a brace axle 310. As the explosive view shown in FIG. 4a, the guidance 330 is disposed inside the protrusion portion 210, the slidable module 450 connects to the top portion 311 of the brace axle 310, and the bottom connection part 312 of the brace axle 310 pivotally connects to the base 400. Wherein the slidable module 450 is moveably coupled to the guidance 330, so the brace axle 310 is capable of sliding back and forth along the guidance 330 through the assistance of the slidable module 450, thereby making the main body 200 of the electronic device adjustably connected to the base 400 and the brace axle 310.

As the preferred embodiment shown in FIG. 4a, the slidable module 450 further comprises a slidable piece 451, a pushing block 452 and an elastic unit 453. As FIG. 4a shows, the slidable piece 451 connects to the top portion 311 of the brace axle 310, the pushing block 452 connected to the top of the sliding piece 451. As FIG. 4a shows, one end of the elastic unit 453 is preferably connected to the bottom end of the guidance 330 by a positioning device 454 such as a screw, while the other end contacting with the pushing block 452. However, in another embodiment, it may also use the rivet or other positioning devices to connect the elastic unit 453 and the guidance 330.

As FIG. 4a shows, the both side of the slidable piece 451 are preferably equipped with a wear-resisting piece 455, respectively. However, in another embodiment, the wear-resisting piece 455 may be disposed at the both side of the portion where the sliding piece 451 and the brace axle 310 are connected or at the both side of the portion where the sliding piece 451 and the pushing block 452 are connected. As FIG. 4a shows, in this preferably embodiment, the elastic unit 453 is preferred to be a constant force spring with appropriate coefficient of elasticity and capable of supporting the main body 200 of the electrical device. The appropriate coefficient of elasticity mentioned here refers to the condition where the spring used in the brace structure 300 may provide enough elastic force to support the weight of the main body 200 of the electronic device as well as positioning the electronic device after the users finish adjusting its height. However, in another embodiment, the elastic unit 453 may be a linear spring or other type of spring. As the preferred embodiment shown in FIG. 4b, when the brace axle 310 completely extends into the protrusion portion 210 by the slidable module 450, the base 400 may rotate to the folding area 500, whereby the elastic unit 453 exerts a normal force on the pushing block 452 pressing against the brace axle 310 and thereby making the hook 402 fasten to the top 212 of the protrusion portion 210.

As FIG. 4b shows, when the hook 402 is released from the top 212 of the protrusion portion 210, the deformation of the elastic unit 453 resulted from the brace axle 310 extending into the protrusion portion 210 may be recovered and that further draws the brace axle 310 to slide out of the protrusion portion 210, whereby the base 400 may rotate relative to the brace axle 310 and position in the brace position 600. In the preferred embodiment, the elastic force transformed by the elastic power produced from the deformation of the elastic unit 453 is able to provide enough support to the main body 200 of the electronic device as FIG. 4c shows.

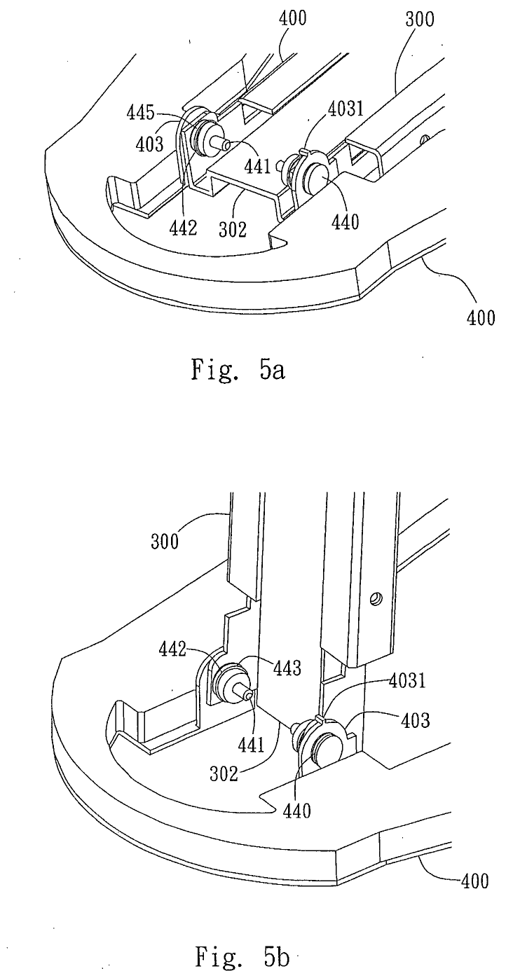

As FIG. 5a shows, the base preferably includes an ear 403, coupled with a joint device 440, such as a bolt, to pivotally connect to the bottom end part 302 of the brace structure 300. As the preferred embodiment shown in FIG. 5a, the joint device 440 includes a bolt 441, a wear-resisting piece 455 and at least a spacer 442, wherein the bolt 441 passes through the ear 403 and the brace structure 300, connecting to the wear-resisting piece 455 and a plurality of the washers 443. However in another embodiment, the joint device 440 may include a bolt and a screw cap used for connecting the base 400 and the brace structure 300. As shown in FIG. 5b, the top of the ear 403 preferably includes a rib 4031. When the base 400 rotates relative to the brace structure 300 and positions in the brace position 600, the rib 4031 presses against the bottom end part 302 of the brace structure 300 and thus prevents the base 400 from further rotating.

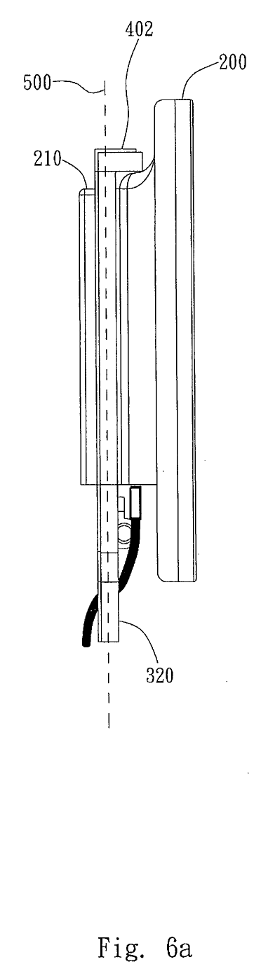

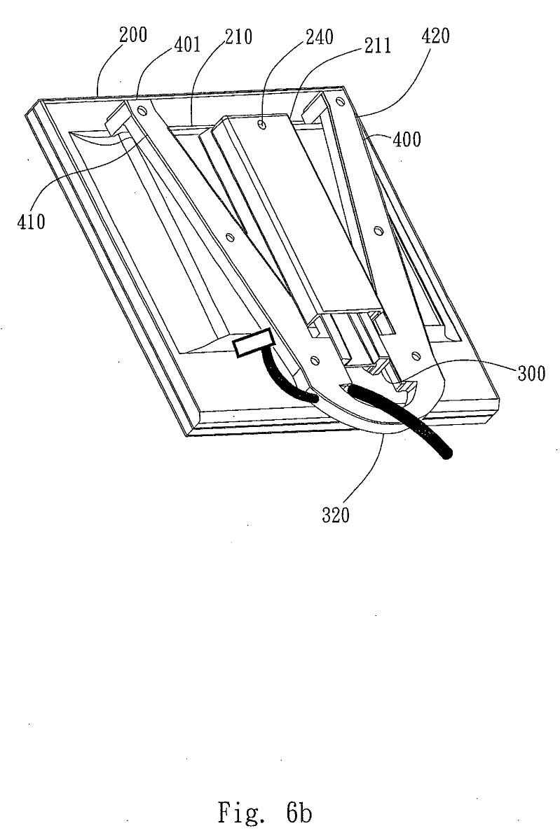

In addition, as the preferred embodiment shown in FIG. 6a, when the base 400 is completely folded in the folding area 500 and hung on the wall, the arc structure 320 of the base 400 may function as a cable arrangement structure. As FIG. 6b shows, the protrusion portion 210 preferably has a hanging hole in the back 211, which is provided for using with a hook set at the wall so that the electronic device is hung on the wall. However in another embodiment, the hanging hole 240 may be located in the tail portion 401 of either the first leg 410 or the second leg 420, and thus the electronic device is hung on the wall with the hook.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A brace stand, provided for use with an electronic device, comprising:
a brace structure having a top end part and a bottom end part, the top end part of the brace structure being connected to the electronic device; and
a base being pivotally connected to the bottom end part of the brace structure, the base having a tail portion and a hook at the tail portion;
wherein the base is capable of rotating relative to the brace structure and positioning between a brace position and a folding area.

2. The brace stand of claim 1, wherein the base includes a first leg and a second leg, each of the first and the second legs has a tail end part formed as the hook and a front end part opposite to the tail end part, the front end parts are joined to each other to form a connection portion, and the connection portion connects the base and the bottom end part of the brace structure.

3. The brace stand of claim 1, wherein the brace stand further comprises a joint device, the base has an ear, the ear of the base and the bottom end part of the brace structure are pivoted via the joint device.

4. The brace stand of claim 3, wherein the ear includes a rib, the rib contacts the bottom end part of the brace structure and further restricts the base from rotation when the base is positioned in the brace position.

5. The brace stand of claim 1, wherein the front end part of the base includes an arc structure.

6. The brace stand of claim 1, wherein the brace structure further comprises a guidance set in a back side housing of the electronic device and a slidable module, the top end part of the brace structure is connected to the back side housing of the electronic device via the guidance, and the slidable module is movably coupled to the guidance whereby the height of the electronic device relative to the base is adjustable.

7. The brace stand of claim 6, wherein the slidable module further comprises:
a brace axle having a top portion and a bottom connection part;
a slidable piece moveably coupled with the guidance and connected to the top portion of the brace axle, wherein the brace axle is capable of sliding back and forth along the guidance through the move of the slidable piece;
a pushing block connected to the top of the sliding piece; and
an elastic unit having one end connected to the bottom end of the guidance by a positioning device, and the other end contacting with the pushing block;
wherein, while the brace axle draws into the guidance in combination with the base rotating to the folding area, the elastic unit exerts a normal force on the pushing block pressing the brace axle so that the hook fastens to the back side housing.

8. An electronic device, comprising:
a main body having a back side housing;
a brace structure having a top end part and a bottom end part, the top end part of the brace structure being connected to the main body; and
a base being pivotally connected to the bottom end part of the brace structure, having a tail portion and a hook at the tail portion;
wherein the base is capable of rotating relative to the brace structure and positioning between a brace position and a folding area, and when the base rotates to the folding area, the hook fastens to the back side housing.

9. The electronic device of claim 8, wherein the base includes a first leg and a second leg, each of the first and the second legs has a tail end part formed as the hook and a front end part opposite the tail end part, the front end parts are joined to each other to form a connection portion, and the connection portion connects the base and the bottom end part of the brace structure.

10. The electronic device of claim 8, wherein the back side housing includes a protrusion portion having a back and a top, the hook fastens to the top of the protrusion portion when the base rotates to the folding area.

11. The electronic device of claim 10, wherein the top of the protrusion portion having a slot, and the hook fastens to the slot when the base is located in the folding area.

12. The electronic device of claim 10, wherein the protrusion portion has a hole at the bottom, and the top end part of the brace structure draws into the hole and connects to the main body.

13. The electronic device of claim 8, wherein the electrical device further comprises a joint device, the base has an ear, the ear of the base and the bottom end part of the brace structure are pivoted via the joint device.

14. The electronic device of claim 13, wherein the ear includes a rib, the rib contacts the bottom end part of the brace structure and further restricts the base from rotation when the base rotates to the brace position.

15. The electronic device of claim 8, wherein the front end part of the base includes an arc structure.

16. The electronic device of claim 8, wherein the brace structure further comprises a guidance set in the back side housing of the electronic device and a slidable module, the top end part of the brace structure is connected to the back side housing of the electronic device via the guidance, and the slidable module adjustably connects to the guidance whereby the height of the electronic device relative to the base is adjustable.

17. The electronic device of claim 16, wherein the slidable module further comprises:
a brace axle having a top portion and a bottom connection part;
a slidable piece moveably coupled with the guidance and connected to the top portion of the brace axle, wherein the brace axle is capable of sliding back and forth along the guidance through the move of the slidable piece;
a pushing block connected to the top of the sliding piece; and
an elastic unit having one end connected to the bottom end of the guidance by a positioning device, and the other end contacting with the pushing block;
wherein, while the brace axle draws into the guidance in combination with the base rotating to the folding area, the elastic unit exerts a normal force on the pushing block pressing the brace axle so that the hook fastens to the back side housing.

18. The electrical device of claim 8, wherein the back side housing includes a hanging hole.
